(19) United States
(12) Patent Application Publication
(10) Pub. No.: US 2019/0188945 A1
(43) Pub. Date: Jun. 20, 2019

(54) Lottery Method

(71) Applicant: Federico Hernandez, San Bruno, CA (US)

(72) Inventor: Federico Hernandez, San Bruno, CA (US)

(21) Appl. No.: 16/222,532

(22) Filed: Dec. 17, 2018

Related U.S. Application Data
(60) Provisional application No. 62/607,853, filed on Dec. 19, 2017.

(51) Int. Cl. G07F 17/32; G06Q 30/02; G06Q 50/34

(52) U.S. Cl. CPC G07F 17/329; G07F 17/3227; G06Q 50/34; G06Q 30/0205

(57) ABSTRACT

A method for conducting lotteries includes distributing the payout to a larger group of participants and creating more interest by directing payouts to smaller geographical areas. For example; a current payout of $1,000,000 maybe converted to, for example, 10 payouts of $100,000 or 100 payouts of $10,000 to produce more winners. The history of lottery winners has shown that many winners of very large payouts ultimately receive little long-term benefit, so a smaller payout to a larger number of participants is likely to show much greater positive results and generate great enthusiasm for purchasing lottery tickets. Further, the zip code lottery may be reduced to one or a small number of zip codes to produce local winners, and motivate participant enthusiasm. The method may be incorporated into the PowerBall® or Mega Millions® lottery games or as a new lottery game, e.g. Guaranteed 100K, or Lottery Guaranteed $100K.

### CROSS-REFERENCE TO RELATED APPLICATIONS

The present application claims the priority of U.S. Provisional Patent Application Ser. No. 62/607,853 filed Dec. 19, 2017, which application is incorporated in its entirety herein by reference.

### BACKGROUND OF THE INVENTION

The present invention relates to lotteries, and in particular to methods for attracting more participants and producing more winners in lotteries the United States and Indian casinos.

Lotteries have become an important source of revenue for public schools and other government activities in the United States. Proceeds from the lotteries go to public education, and greater participation generates greater funding for schools. Unfortunately, the basic form of lotteries in the Unites Sates has not had significant change over time, and the enthusiasm for higher growth is at risk. Thus, the basic form of the lotteries requires changes to maintain enthusiasm, higher growth, and greater participation.

An example of a California lottery on Saturday Jun. 10, 2017, resulted in:
one winner of $435, 000,000;
two winners of $322,016;
nine winners of $18,319;
232 winners of $355;
542 winners of $158;
12,649 winners of $7;
10,357 winners of $9;
81,926 winners of $5; and
199,883 winners of $4.
   thus, for a total payout of over 437 million dollars, only three winners receive life changing payouts, and only 12 winners receive payouts over $355. Such results do little to excite a larger percent of the United States population who have no realistic expectation of receiving a $100,000 or more winnings.

Further, with such few winners, members of the general public are not likely to personally know any winner. Such detachment from the winning experience fails to result in expectations of future winnings for most people, Still further, winners are not likely to live in the same general area as others whom would be motivated to buy lottery tickets if a neighbor won a substantial amount.

### BRIEF SUMMARY OF THE INVENTION

The present invention addresses the above and other needs by providing a method for conducting lotteries in the United States and in Indian casinos which includes distributing the payout to a larger group of participants and creating more local interest by directing payouts to smaller geographical areas. For example; a current payout of $1,00000,000 maybe converted to, for example, 10 payouts of $100,000 or 100 payouts of $10,000 to produce more winners. The history of lottery winners has shown that one or a small number of winners of very large payout ultimately receive very little long-term benefit, so smaller payouts to a larger number of participants it will likely to show much greater positive results. The payouts may be distributed based on geography or participant characteristics to produce local winners, and motivate participant enthusiasm. For example, the region may be reduced to a small number of zip codes or a single zip code number, or house address. Participants may be reduced based on participant characteristic, social security number, license plate number, DMV drivers license number, DMV (ID) identification card number, email address, social media handle, birth date, anniversary date, cell phone number, landline phone number. Further, a mobile app may be used to buy a lottery ticket in addition to purchasing from a store, giving the buyer choices, making it more convenient to purchase a lottery tickets, and thereby increasing lottery ticket sales.

In accordance with one aspect of the invention, there is provided a method for increasing participant enthusiasm by dividing smaller payout between more winners. Experience has shown that many, if not most winners of multi-million dollar lotteries, end up worse off than before they received the large payout. A lower payout, for example, $100,000 net winnings out of the gross amount of $150,000, will generally have a large positive influence on the average persons life, for example, paying off a mortgage early to provide a secure retirement. Payouts like $100,000 creates participant enthusiasm because the expectation of winning is substantially increased, and the smaller payout will still provide a significant improvement in the winners' lives. Also will create a great wealth effect amongst many Americans. Finally it will help grow the American economy and increase the Gross Domestic Product (GDP). The stronger the American economy is the stronger America will be as a global financial powerhouse.

In accordance with another aspect of the invention, there is provided a method for increasing participant enthusiasm by distributing winnings to smaller geographical local areas. The excitement of winning is not only present in the winners, but also in their neighbors. A single jackpot payout of $10,000,000 or more may draw brief media attention, but a $100,000 payout to a neighbor is much more personal and will have more sustainable enthusiasm. Watching a neighbor or friend pay off bills and attain financial security is much more real than a single television sound bite of coverage, and every time neighbors see the winner, the thought of “why not me” will create long term enthusiasm amongst family, friends and stir up social media.

In accordance with still another aspect of the invention, there is provided a method for providing awards having a greater benefit to society. As we have seen, the huge lottery awards often result in no long-term benefit to the individual. When individuals experience long-term financial benefits, society in general benefits from increased financial stability. Thus, when lottery awards are optimized to provide the greatest long-term individual benefit, society also receives the greatest long-term benefit.

In accordance with yet another aspect of the invention, there is provided a method for increasing the expectation of receiving a substantial winnings. Using current strategies, one example of the California lottery with a Jackpot of $437,367,817 provided substantial winnings (e.g., over $150,000, gross) to only three winners. Alternatively, example, 2,915 awards of $150,000 gross winnings were possible. The life changing gross winnings of $150,000 awards to 2,915 winners provides both a better benefit to the individual winners and also to society.

In accordance with another aspect of the invention, there is provided a location based lottery method. In order to provide multiple smaller awards versus a single very large award, some method of dividing the lottery into multiple sub-lotteries is required. One method is location based. The population is divided based on zip code, area code, city, county, or any other location based category. The lottery may be divided to provide generally uniform payouts in sub-area determined after ticket sales, or using pre-selected sub areas and basing payouts on the number of tickets purchased in each sub-area. For example, a zip code based lottery for a sub-area having 18,000 residents could not support $100k in awards, but the chance of winning with a smaller pool of people would increase. If 50% of the 18,000 residents played the zip code based lottery and the total award is $10,000 there could be six winners: one winner receiving $5,000 and five winners would receive $1,000 each, or ten winners receiving $1,000 each.

In accordance with still another aspect of the invention, there is provided a location based lottery method. The location based lottery method forms groups of the zip codes, area codes, cities, or counties where each group has at least enough ticket purchases to provide a minimum award.

In accordance with yet another aspect of the invention, there is provided a location based lottery method for Indian casinos. Indian casinos in the United States collect almost $33 billions per year, almost twice the collection of non-Indian casinos in the Untied States. However, Indian casinos do not offer typical lotteries. A location based lottery system is ideal for Indian casinos because the Indian casinos draw customers from a large geographic region and offering awards targeting locations the customers are drawn from, creates a more interesting experience for each customer. A customer may buy a lottery ticket at an Indian casino and provide a location that is associated with the ticket. For example, the customer zip code, area code, city, or county. Sub-areas may be fixed or formed based on the number of tickets sold in each sub-area.

In accordance with another aspect of the invention, there is provided a method for localizing Indian casino lotteries. Each India casino can offer customers two options, either entering a lottery limited to tickets purchased from the casino they are in, or joining a larger state lottery.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a method for determining reduced payouts according to the present invention.

FIG. 2 shows a method for determining local area based payouts according to the present invention.

FIG. 3 shows a method for determining sub-areas according to the present invention.

FIG. 4 shows another method for determining sub-areas according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

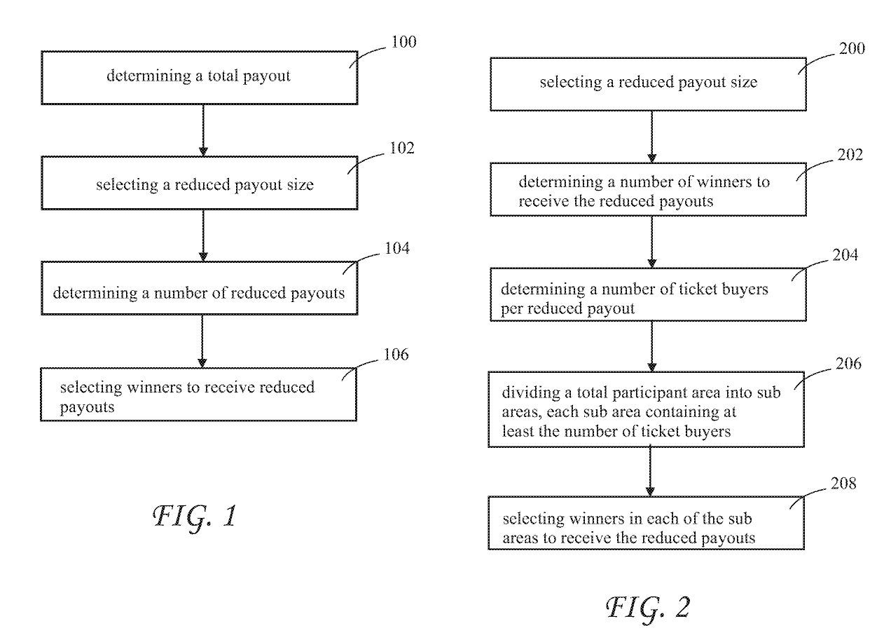

A method for determining reduced payouts according to the present invention is shown in FIG. 1. The method includes determining a total payout at step 100, selecting a reduced payout size at step 102, determining a number of reduced payouts in step 104, and selecting winners to receive reduced payouts at step 106. For example, for a jackpot net amount $1,000,000.00, instead of one person, there would be ten winning tickets of $100,000.00. If the jackpot was $2,000,000.00, twenty winning tickets would win $100,000.00.

A method for determining local area based payouts according to the present invention is shown in FIG. 2. The method includes selecting a reduced payout size at step 200, determining a number of winners to receive the reduced payouts at step 202, determining a number of ticket buyers per reduced payout at step 204, dividing a total participant area into sub areas, each sub area containing at least the number of ticket buyers at step 206, and selecting winners in each of the sub areas to receive the reduced payouts at step 208. The sub areas may be based on zip codes, area codes, cities, counties, and any geographic area of either a ticket purchaser, or a ticket seller.

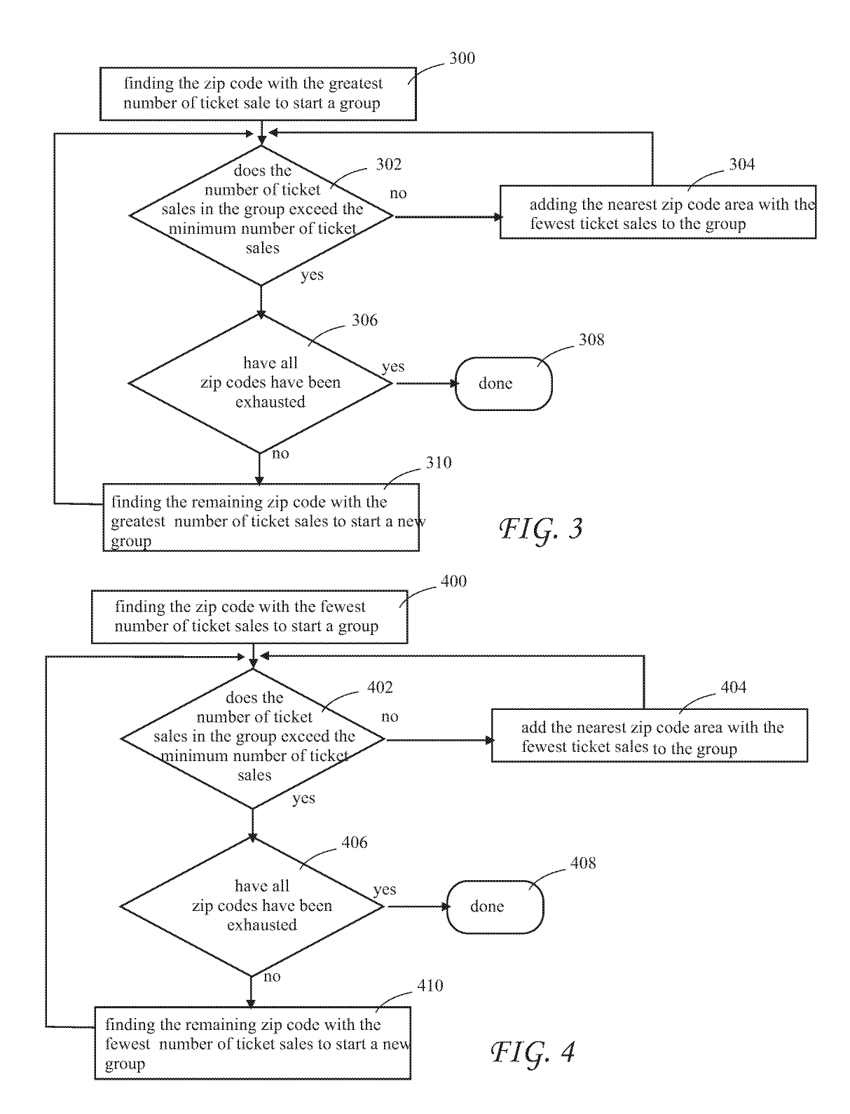

An example of determining sub-areas is shown in FIG. 3. The method includes finding the zip code with the greatest number of ticket sales to start a group at step 300, determining if the number of ticket sales in the group exceeds a minimum number of ticket sales to support the target award(s) at step 302. If the number of ticket sales in the group does not exceed the minimum number of ticket sales, adding the nearest zip code area with the fewest ticket sales to the group at step 304, and returning to step 302. If the number of ticket sales in the group exceeded the minimum number of ticket sales, determining if zip codes have been exhausted at step 306. If all zip codes have been exhausted, completing the method at step 308. If all zip codes have not been exhausted, finding the remaining zip code with the greatest number of ticket sales to start a new group and returning to step 302, at step 310.

The method of FIG. 3 recognizes that adding the nearest zip code area with the fewest ticket sales at step 304 is not entirely defining. In one example, the zip codes plus or minus two may be reviewed and the zip code with the fewest ticket sales selected. Further, the last step may be reached and the last group of zip codes may have fewer than the minimum number of ticket sales. In this instance, the ticket sales in the remaining zip codes in the last step may be split between closed groups of zip codes, the remaining zip codes with the greatest ticket sales added to the groups with the fewest total ticket sales.

Another example of determining sub-areas is shown in FIG. 4. The method includes finding the zip code with the fewest number of ticket sales to start a group at step 400. Determining if the number of ticket sales in the group exceeds a minimum number of ticket sales to support the target award(s) at step 402. If the number of ticket sales in the group does not exceed the minimum number of ticket sales, adding the nearest zip code area with the fewest ticket sales to the group at step 404, and returning to step 402. If the number of ticket sales in the group exceeds the minimum number of ticket sales, determining if zip codes have been exhausted at step 406. If all zip codes have been exhausted, completing the method at step 408. If all zip codes have not been exhausted, finding the remaining zip code with the fewest number of ticket sales to start a new group at step 410 and returning to step 402.

The method of FIG. 4 recognizes that adding the nearest zip code area with the fewest ticket sales at step 404 is not entirely defining. In one example, the zip codes plus or minus two may be reviewed and the zip code with the fewest ticket sales selected. Further, the last step may be reached and the last group of zip codes formed may have fewer than the minimum number of ticket sales. In this instance, the ticket sales in the remaining zip codes in the last step may be split between closed groups of zip codes, the remaining zip codes with the greatest ticket sales added to the groups with the fewest total ticket sales.

An example of a lottery according to FIG. 3 or 4 may combine four zip codes having a total of $150,000 in ticket sales. A single drawing may produce one winner of $100,000.

In another example, an area based lottery may have ten payouts of $1,000 each from sales of at least $14,000. If one area (for example a single zip code) only generates $6,000 in ticket sales, that area may be combined with an adjacent area having $8,000 in ticket sales to arrive at a $14,000 sales.

While the invention herein disclosed has been described by means of specific embodiments and applications thereof, numerous modifications and variations could be made thereto by those skilled in the art without departing from the scope of the invention set forth in the claims.

I claim:

1. A method for conducting a lottery, comprising:
determining a total payout;
selecting a reduced payout size;
determining a number of reduced payouts;
determining sub-areas for each payout; and
selecting winners to receive the reduced payouts.

2. The method of claim 1, wherein the sub-areas a geographic area, of either a ticket purchaser, or a ticket seller.

3. The method of claim 2, wherein the geographic area is based on zip codes, area codes, cities, or counties, of either the ticket purchaser, or the ticket seller.

4. The method of claim 2, wherein the geographic area is based on the ticket seller.

5. The method of claim 2, wherein the sub-areas are determined to exceed a minimum number of ticket sales in each sub-area.

6. The method of claim 5, wherein the sub-areas are determined using the steps:
a) finding the zip code with the greatest number of ticket sales to start a group;
b) determining if the number of ticket sales in the group exceeds a minimum number of ticket sales to support the target award;
c) adding the nearest zip code area with the fewest ticket sales to the group if the number of ticket sales in the group does not exceed the minimum number of ticket sales and returning to step c;
d) determining if zip codes have been exhausted if the number of ticket sales in the group exceeded the minimum number of ticket sales;
e) completing the method if all zip codes have been exhausted; and
f) finding the remaining zip code with the greatest number of ticket sales to start a new group if all zip codes have not been exhausted and returning to step b.

7. The method of claim 6, wherein the ticket sales in the remaining zip codes in the last step may be split between closed groups of zip codes, the remaining zip codes with the greatest ticket sales added to the groups with the fewest total ticket sales.

8. The method of claim 5, wherein the sub-areas are determined using the steps:
a) finding the zip code with the fewest number of ticket sales to start a group;
b) determining if the number of ticket sales in the group exceeds a minimum number of ticket sales to support the target award;
c) if the number of ticket sales in the group does not exceed the minimum number of ticket sales, adding the nearest zip code area with the fewest ticket sales to the group and returning to step c;
d) if the number of ticket sales in the group exceeded the minimum number of ticket sales, determining if zip codes have been exhausted;
e) if all zip codes have been exhausted, completing the method; and
f) if all zip codes have not been exhausted, finding the remaining zip code with the fewest number of ticket sales to start a new group and returning to step b.

9. The method of claim 8, wherein if the total ticket sales in the remaining zip codes is less than the minimum number of ticket sales, the ticket sales in the remaining zip codes in step (f) may be split between closed groups of zip codes, the remaining zip codes with the greatest ticket sales added to the groups with the fewest total ticket sales.

10. A method for conducting a lottery, comprising:
selecting a reduced payout size;
determining a number of winners to receive the reduced payouts;
determining a number of ticket buyers per reduced payouts;
dividing a total participant area into sub areas, each sub area containing at least the number of ticket buyers; and
selecting winners in each of the sub areas to receive the reduced payouts.
